(19) United States
(12) Patent Application Publication
(10) Pub. No.: US 2024/0017107 A1
(43) Pub. Date: Jan. 18, 2024

(54) FIRE SPRINKLER ATTACHMENT CONFIGURED TO FIT OVER A PIPE OUTLET AND TO CONNECT TO A FIRE SPRINKLER OR PIPE OR OTHER MATERIAL

(71) Applicant: NORTHARK PRECISION, LLC, Rogers, AR (US)

(72) Inventor: Ryan Salter, Rogers, AR (US)

(21) Appl. No.: 18/223,273

(22) Filed: Jul. 18, 2023

Related U.S. Application Data
(60) Provisional application No. 63/390,103, filed on Jul. 18, 2022.

(51) Int. Cl. A62C 35/68; F16L 3/08

(52) U.S. Cl. CPC A62C 35/68; F16L 3/08

(57) ABSTRACT

A fire sprinkler attachment configured to fit over a pipe outlet and to connect to a fire sprinkler or pipe is disclosed. The fire sprinkler attachment includes a connecting member configured to receive a sprinkler connection portion of the fire sprinkler or pipe. The connecting member includes an internal member and a sealing member. The connecting member further includes flanges having grooves. The flanges encompass a U-shaped member. The U-shaped member receives a sprinkler pipe having a pipe outlet. The U-shaped member fastens around and holds the sprinkler pipe and the pipe outlet with the help of locking units at the flanges. The sealing member forms a watertight seal between the internal member and the pipe outlet. The fire sprinkler attachment fits over the sprinkler pipe, receives the entire external diameter of the pipe outlet and connects to a smaller or larger diameter fire sprinkler.

The present application claims the benefit of U.S. Provisional Application No. 63/390,103, filed Jul. 18, 2022; all of which is incorporated herein by reference.

### FIELD OF INVENTION

The present subject matter generally relates to fire sprinkler accessories. More specifically, the present subject matter relates to a fire sprinkler attachment or fire sprinkler fitting configured to fit over a pipe outlet so that the outlet can be utilized for a larger sprinkler or pipe without the need to install a mechanical tee or similar fitting.

### BACKGROUND OF INVENTION

It is known that there are a variety of accessories to retrofit and expand fire sprinkler systems. One such accessory includes a fire sprinkler mechanical tee. FIG. 1 shows a fire sprinkler mechanical tee 10, as known in the art. A typical fire sprinkler mechanical tee 10 includes a first housing 12 and a second housing 14. First housing 12 indicates an upper housing and second housing 14 indicates a lower housing. Each of first housing 12 and second housing 14 comes in a semi-circular configuration with flanges extending from respective distal ends. As can be seen in FIG. 1, first housing 12 includes first flanges 16 extending from its distal ends. Second housing 14 includes second flanges 18 extending from its distal ends. First housing 12 includes an outlet receiving section 20. Outlet receiving section 20 indicates a collar-like structure to receive a grooved coupling (as shown in FIG. 1) or configured for receiving a threaded fire sprinkler or threaded pipe 30 having female threads 32, as shown in FIG. 2.

Further, flanges 18 and 16 receive fasteners or bolts 22 through holes (not shown). Fasteners 22 present locking units or nuts 24 for locking the flanges 18. In one example, first housing 12 includes a gasket or sealing member 26. Gasket 26 creates a seal between a pipe 28 and first housing 12. FIG. 2 shows an operational view of first housing 12 and second housing 14 encasing a pipe 28. As can be seen, hose 28 is positioned between first housing 12 and second housing 14, and locking units 24 are tightened at fasteners 22. Tightening fasteners 22 creates a mechanical force bringing first housing 12 and second housing 14 closer to pipe 28. Here, gasket 26 creates a water tight seal on pipe 28.

FIG. 3 shows another fire sprinkler attachment or U-bolt mechanical tee as known in the art. Here, fire sprinkler attachment 50 comes in a U-shape configuration. Fire sprinkler attachment 50 includes a housing 52 having flanges 54 extending from its sides. Flanges 54 present grooves or notches 55 at the end. Fire sprinkler attachment 50 encompasses an outlet receiving section 56 having an opening 57. Further, housing 52 receives a gasket or sealing member 58. In the present embodiment, flanges 54 receive a U-shaped member or U-shaped bolt 60. As can be seen, the distal ends of U-shaped member 60 connect at grooves 55 of flanges 54. U-shaped member 60 includes threading portions 62 configured for receiving locking units or nuts 64 for locking a pipe (not shown) with the help of U-shaped member 60. Tabs 51 extend into a predrilled hole in the pipe and help lock it to fixed position on the pipe. In operation, the tabs 51 insert through the gap formed between housing 52 and U-shaped member 60. Subsequently, locking units 64 tighten to lock the attachment in place. Here, gasket 58 creates a water tight seal between the pipe and housing 52.

Several other mechanisms have also been disclosed in the past. One such example is disclosed in a PCT Publication No. 2021186369, entitled, “Quick connect sprinkler” (“the '369 Publication”). The '369 Publication discloses a coupling assembly that includes a sprinkler and a fitting. The sprinkler includes an inlet end defining a sprinkler interface on a protrusion. The fitting extends from a first end that receives the pipe to a second end that includes a fitting interface. The inlet end of the sprinkler couples with the second end and the fitting interface of the fitting couples with the sprinkler interface. The fitting interface and the sprinkler interface limit rotation of the sprinkler relative to the fitting and form a fluid seal between the fitting and the sprinkler.

Another example is disclosed in a United States Publication No. 20210316179, entitled, “Fire protection sprinkler assemblies and installations with adjustable push-to-connect fittings” (“the '179 Publication”). The '179 Publication discloses adjustable fire protection assemblies and methods. The assembly includes a sprinkler having a body with an outer encasing surface and a deflector supported from the body. An escutcheon having a receiver and a rim surround the fire protection sprinkler to define an aperture between the receiver and the sprinkler. A push-to-connect fitting of the assembly includes a tubular member with an end for connection to a pipe and an internal conduit that receives the sprinkler body. A seal member and a retaining ring are disposed within the tubular member to form an adjustable seal and grip about the sprinkler body. A releasing member translates to disengage the retaining ring from the sprinkler body; and the escutcheon translates with respect to the tubular member in a sliding surface engagement to define an adjustable deflector-to-rim distance between the rim of the escutcheon and the deflector of the sprinkler.

Although the above-discussed fire sprinkler attachments are useful for connecting a pipe outlet and a fire sprinkler, they have few problems. For example, the fire sprinkler attachments as shown in FIGS. 1 and 3, come in a standard size and therefore different fire sprinkler attachments are needed for connecting different sized fire sprinklers.

Therefore, there is a need for a fire sprinkler attachment or fire sprinkler fitting configured to fit over a pipe outlet without the need to install a mechanical tee which requires a process of drilling into the pipe or similar fitting and connect to different sized fire sprinkler.

### SUMMARY

It is an object of the present subject matter to provide fire sprinkler attachment configured to fit over a pipe outlet and to connect to a fire sprinkler or pipe and that avoids the drawbacks of known fire sprinkler attachments or mechanical tees.

It is another object of the present subject matter to provide a fire sprinkler attachment configured to fit over a pipe outlet so that the existing pipe outlet can be utilized for a larger sprinkler or pipe without the need to install a mechanical tee or similar fitting.

In order to achieve one or more objects, the present subject matter presents a fire sprinkler attachment configured to fit over a pipe outlet and to connect to a fire sprinkler. The fire sprinkler attachment includes a connecting member configured to receive the threaded or grooved portion of the fire sprinkler or pipe. The connecting member includes an internal member and a sealing member. The connecting member further includes flanges having grooves. The flanges encompass a U-shaped member. The U-shaped member receives the external portion of a smaller outlet and having a larger outlet. The U-shaped member fastens around and holds the pipe and the smaller outlet with the help of locking units at the flanges. The sealing member forms a watertight seal between the internal member and the pipe outlet.

In one advantageous feature of the present subject matter, the fire sprinkler attachment allows to fit the entire diameter of the existing pipe outlet and connects to a larger fire sprinkler or pipe with little loss in internal restriction.

In another advantageous feature of the present subject matter, the fire sprinkler attachment presents use for upsizing fire sprinklers that have larger threads or grooved connection than the existing sprinkler outlets.

In yet another advantageous feature of the present subject matter, the U-shaped member fastens around and holds the pipe outlet and the attachment with the help of locking units at the flanges. This reduces the number of components needed to connect the pipe outlet to the fire sprinkler.

In yet another advantageous feature of the present subject matter, the fire sprinkler attachment fits over an existing pipe outlet so that the outlet can be utilized for a larger fire sprinkler or pipe without the need to install a mechanical tee or similar fitting.

Features and advantages of the subject matter hereof will become more apparent in light of the following detailed description of selected embodiments, as illustrated in the accompanying FIGUREs. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates a grooved fire sprinkler mechanical tee, in accordance with prior art;

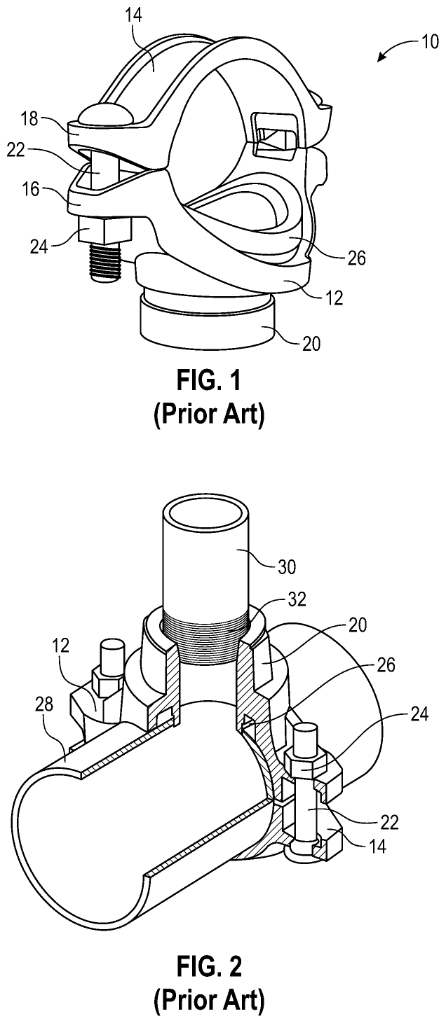

FIG. 2 illustrates a threaded fire sprinkler mechanical tee, in accordance with prior art;

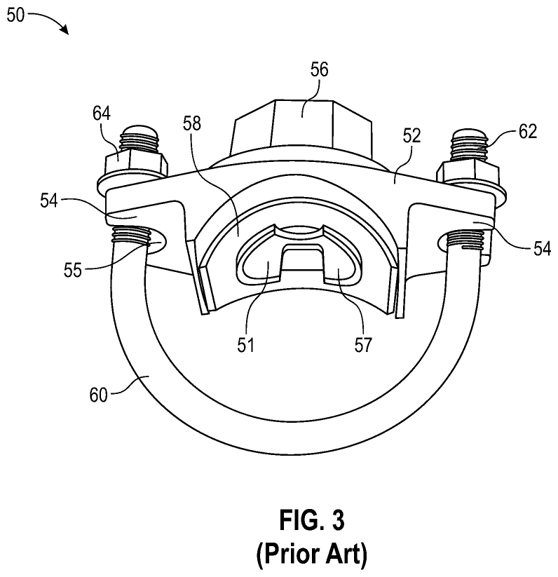

FIG. 3 illustrates another fire sprinkler mechanical tee with u-bolt, in accordance with prior art;

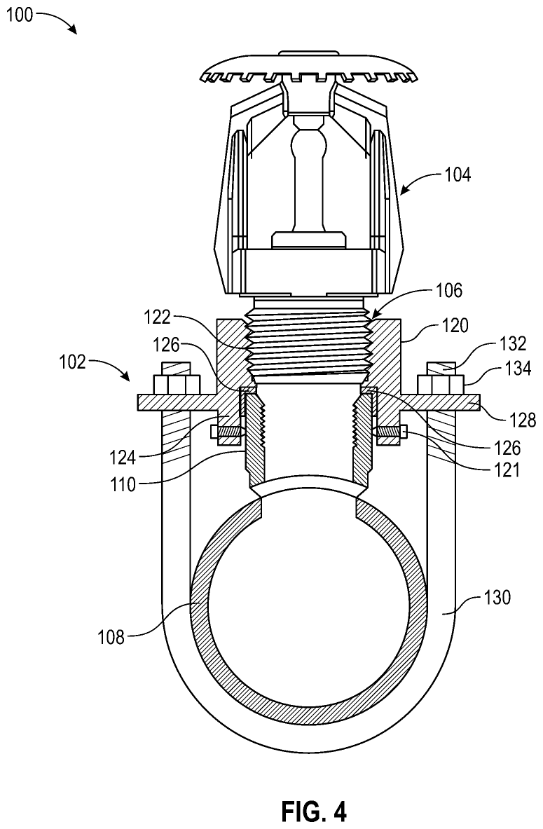

FIG. 4 illustrates a fire sprinkler attachment, in accordance with one embodiment of the present subject matter;

FIG. 5 illustrates the fire sprinkler attachment, in accordance with one embodiment of the present subject matter;

FIGS. 6 and 7 illustrates a fire sprinkler and a cross section of a fire sprinkler pipe with an standard outlet, respectively;

FIG. 8 illustrates a cross section view of the fire sprinkler attachment fit over the outlet of a fire sprinkler pipe, in accordance with one embodiment of the present subject matter; and

FIGS. 9A-9C illustrate alternative embodiments of the present subject matter.

It will be noted that throughout the appended drawings, like features are identified by like reference numerals.

### DETAILED DESCRIPTION OF THE EMBODIMENTS

Before the present features and working principle of a fire sprinkler attachment is described, it is to be understood that this subject matter is not limited to the particular device as described, since it may vary within the specification indicated. Various features of the fire sprinkler attachment might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes a fire sprinkler attachment configured to fit over a pipe outlet and to connect to a fire sprinkler. The fire sprinkler attachment includes a connecting member configured to receive the threads of a fire sprinkler. The connecting member includes an internal member and a sealing member. The connecting member further includes flanges having grooves. The flanges encompass a U-shaped member. The U-shaped member receives a sprinkler pipe having a pipe outlet. The U-shaped member fastens around and holds the sprinkler pipe and the outlet with the help of locking units at the flanges. The sealing member forms a watertight seal between the internal member and the pipe outlet. The fire sprinkler attachment fits over the sprinkler pipe, receives the entire external diameter of the pipe outlet and connects to a smaller or larger diameter fire sprinkler.

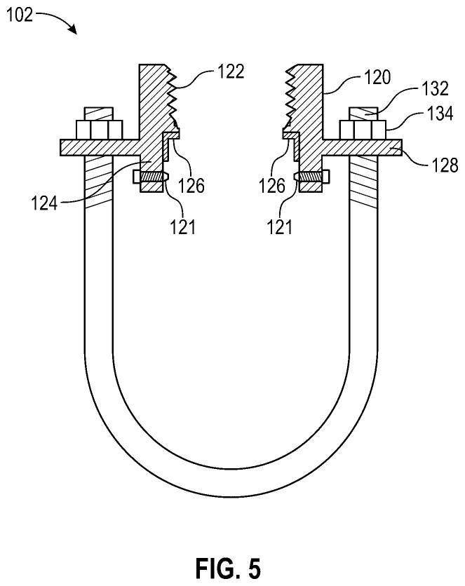

Various features and embodiments of a fire sprinkler attachment configured to fit over a pipe outlet and to connect to a fire sprinkler are explained in conjunction with the description of FIGS. 4-8.

The present subject matter discloses fire sprinkler attachment configured to fit over a pipe outlet and to connect to a fire sprinkler. FIG. 4 shows a fire sprinkler assembly 100 including a fire sprinkler attachment 102, in accordance with one exemplary embodiment of the present subject matter. Fire sprinkler assembly 100 includes fire sprinkler attachment 102 connecting fire sprinkler 104 and sprinkler pipe 108. As can be seen from FIG. 4, fire sprinkler attachment 102 connects to fire sprinkler 104 at sprinkler threaded portion 106. Further, fire sprinkler attachment 102 connects to sprinkler pipe 108 at the pipe outlet 110. Fire sprinkler 104 and sprinkler hose sprinkler pipe 108 comes in different sizes depending on the need or as known in the art.

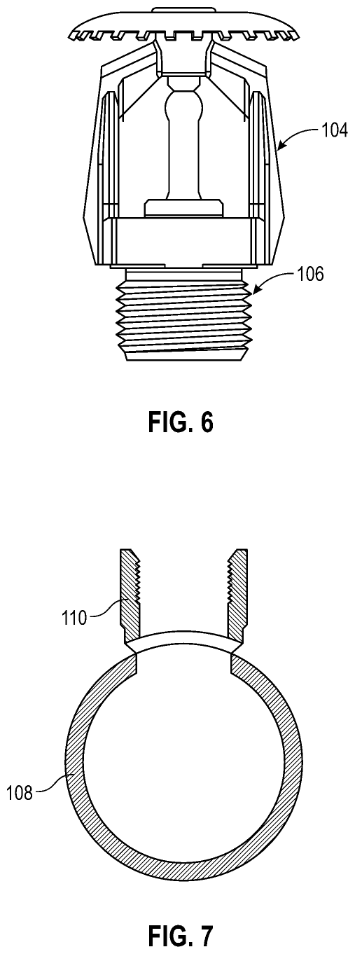

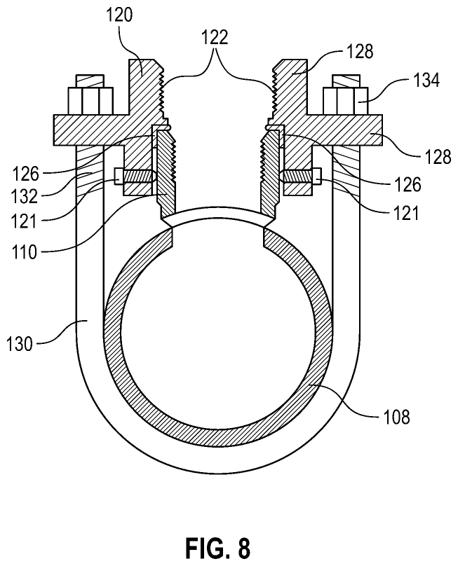

Now referring to FIG. 5, the constructional features of fire sprinkler attachment 102 is explained. Fire sprinkler attachment 102 is also referred to as “Quickolet”. Fire sprinkler attachment 102 includes connecting member or “Quickolet” 120. Connecting member 120 is made of a metal or hard plastic or any other suitable material. Connecting member 120 comes in different sizes depending on the need. Connecting member 120 encompasses first threaded portion 122 at its inner side. First threaded portion 122 configures to receive fire sprinkler 104 at its sprinkler threaded portion 106. FIG. 6 shows a front view of fire sprinkler 104. As can be seen, fire sprinkler 104 includes sprinkler threaded portion 106 at the surrounds and firmly connects to sprinkler threaded portion 106, as shown in FIG. 4.

Connecting member 120 encompasses a smooth internal member 124. Internal member 124 configures to fit over the outside of the pipe outlet 110. FIG. 7 shows a cross section view of sprinkler pipe 108 having an pipe outlet 110. In accordance with the present subject matter, internal member 124 fits over the outside i.e., outside diameter of the pipe outlet 110 and a sealing member 126 is made to sit in between internal member 124 and pipe outlet 110. Sealing member 126 includes a gasket made of silicone, rubber or any other suitable material. Sealing member 126 firmly sits and forms a watertight seal in between internal member 124 and pipe outlet 110.

Connecting member 120 encompasses flanges 128. Flanges 128 extend at a right angle from connecting member 120. Flanges 128 encompass grooves or notches (not shown). Fire sprinkler attachment 102 includes a U-shaped member 130. U-shaped member 130 indicates a U-bolt or U-shaped fastener having second threaded portions 132 at its distal ends. U-shaped member 130 is made of metal or hard plastic or any other suitable material. U-shaped member 130 draws through the grooves and receives locking units or nuts 134. Locking units 130 are tightened at second threaded portions 132 for locking the position of U-shaped member 130.

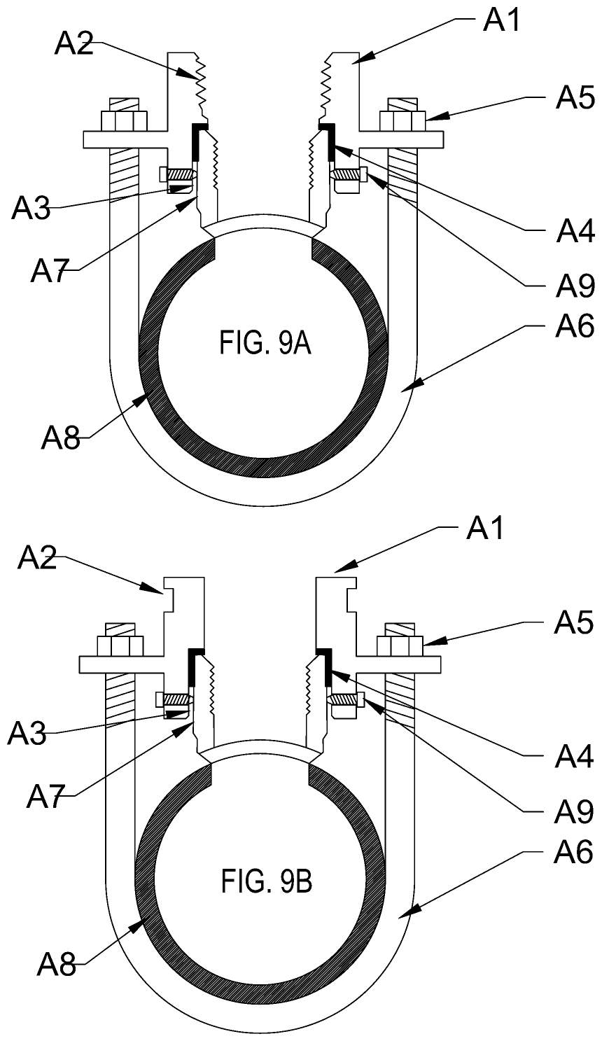

In operation, connecting member 120 connects to fire sprinkler 104 at sprinkler threaded portion 106, as shown in at least FIG. 4. The size of connecting member 120 is adjusted to connect a smaller or larger diameter sprinkler threaded portion 106. Further, sprinkler pipe 108 draws through U-shaped member 130. Subsequently, sealing member 126 is placed at internal member 124. Here, internal member 124 has a larger diameter than pipe outlet 110 and is made to fit over the outside of pipe outlet 110. Once pipe outlet 110 is fit inside internal member 124, sealing member 126 forms a watertight seal between internal member 124 and pipe outlet 110. FIG. 8 shows a cross section view, sprinkler pipe 108 drawn through U-shaped member 130 and pipe outlet 110 connected at internal member 124. Here, a user (not shown) tightens the U-shaped member 130 depending on the size of sprinkler pipe 108. In other words, U-shaped member 130 fastens around and holds existing sprinkler pipe 108 and pipe outlet 110 with the help of locking units 134 at flanges 128.

In accordance with the present subject matter, the size of connecting member 120 is varied such that fire sprinkler attachment 102 can be used with any fire sprinkler 104. Further, internal member 124 accommodates pipe outlet 110 of any size or diameter. As a result, fire sprinkler attachment 102 can be used to connect a smaller or larger diameter fire sprinkler 104 (sprinkler threaded portion 106) and while also receiving the entire external diameter of pipe outlet 110 resulting in little loss in internal restriction. This allows the fire sprinkler attachment 102 to be used for upsizing fire sprinkler 104 or sprinkler threaded portion 106 that have larger threads than pipe outlet 110, or vice versa.

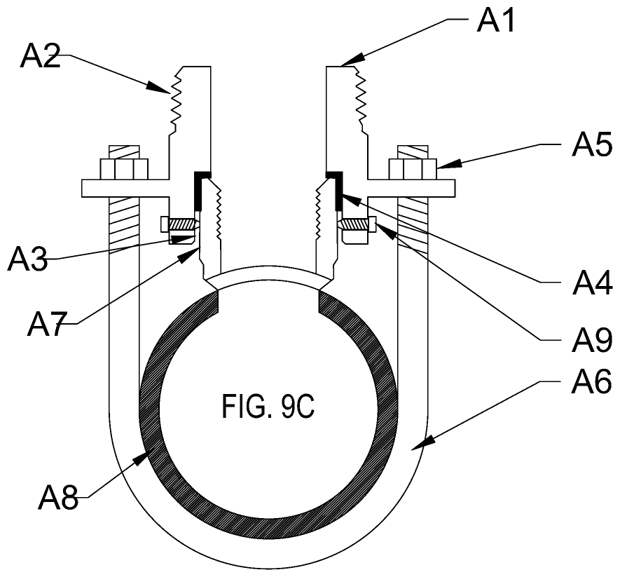

FIGS. 9A, 9B, and 9C depict alternative embodiments of the presently disclosed subject matter. The above description of how the various components of the present disclosure cooperate with one another can be taken to explain the various embodiments of FIG. 8. Likewise, the construction of the different embodiments of FIGS. 9A, 9B and 9C show different configurations of the attachments that may be suitable for different types of sprinkler attachments

With reference to FIGS. 9A, 9B, and 9C, connection member A1 includes connection method A2. Internal member A3 fits over pipe outlet, with sealing member A4. Locking nuts A5 connect U-shaped member A6 and hold pipe outlet A7 includes threads that interface sprinkler pipe A8. Set screw A9 holds attachment in place.

Based on the above, it is evident that the presently disclosed fire sprinkler attachment can be used to fit over an existing pipe outlet and connect to a larger or smaller fire sprinkler or sprinkler threaded portion without the need to install a mechanical tee or similar fitting.

A person skilled in the art appreciates that the fire sprinkler attachment may come in a variety of sizes depending on the need and comfort of the user. Further, different materials in addition to or instead of materials described herein may also be used and such implementations may be construed to be within the scope of the present subject matter. Further, many changes in the design and placement of components may take place without deviating from the scope of the presently disclosed fire sprinkler attachment.

In the above description, numerous specific details are set forth such as examples of some embodiments, specific components, devices, methods, in order to provide a thorough understanding of embodiments of the present subject matter. It will be apparent to a person of ordinary skill in the art that these specific details need not be employed, and should not be construed to limit the scope of the subject matter.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the subject matter, it is intended that all matter contained in the above description or shown in the accompanying drawings shall be interpreted as illustrative and not in a limiting sense.

The foregoing description of embodiments is provided to enable any person skilled in the art to make and use the subject matter. Various modifications to these embodiments will be readily apparent to those skilled in the art, and the novel principles and subject matter disclosed herein may be applied to other embodiments without the use of the innovative faculty. It is contemplated that additional embodiments are within the spirit and true scope of the disclosed subject matter.

We claim:

1. A fire sprinkler attachment configured to fit over a pipe outlet and to connect to a fire sprinkler or pipe:
said fire sprinkler attachment comprising a connecting member configured to receive a sprinkler connection portion of the fire sprinkler or pipe, said connecting member comprising an internal member and a sealing member;
said connecting member further comprising flanges comprising grooves, said flanges encompassing a U-shaped member for receiving a sprinkler pipe, said sprinkler pipe comprising a pipe outlet;
said U-shaped member fastening around and holding said sprinkler pipe and said pipe outlet with the help of locking units at said flanges;
said sealing member forming a watertight seal between said internal member and said pipe outlet;
said fire sprinkler attachment fitting over said sprinkler pipe for receiving the entire external diameter of the pipe outlet and connecting to a smaller or larger diameter fire sprinkler.

2. The apparatus of claim 1, wherein said sprinkler attachment comprises a configuration for fitting over a pipe outlet, such that an existing pipe outlet enables use for a larger sprinkler system.

3. The apparatus of claim 1, wherein said sprinkler attachment comprises a configuration for fitting the entire diameter of an existing pipe outlet with little loss in internal restriction.

4. The apparatus of claim 1, further comprising, larger connections for adaptation of the sprinkler assembly to permit use in larger sprinkler or pipe while avoid the need for a mechanical tee (“T”) or similar fitting.

5. The apparatus of claim 1, further comprising adaptation for a quick-connect attachment to said to a connection member of a fire sprinkler system.

6. The apparatus of claim 1, further comprising a sealing member for providing a watertight seal between fire sprinkler attachment and an existing fire sprinkler system.

7. The apparatus of claim 1, wherein said internal member fits over the outside diameter of the pipe outlet and a sealing member is made to sit in between said internal member and said pipe outlet.

8. The apparatus of claim 1, further comprising configuration for sprinkler attachments of various sizes on a single fire sprinkler system.

9. A method for forming a fire sprinkler attachment for fitting over a sprinkler pipe and connection to a smaller or larger diameter fire sprinkler, comprising the steps of
forming a fire sprinkler attachment configured to fit over a pipe outlet and to connect to a fire sprinkler or pipe:
further forming said fire sprinkler attachment to comprise a connecting member configured to receive a sprinkler threaded portion of the fire sprinkler, said connecting member comprising an internal member and a sealing member;
forming said connecting member to further comprise flanges, wherein said flanges comprise grooves,
forming said flanges to encompass a U-shaped member for receiving a sprinkler pipe, said sprinkler pipe comprising a pipe outlet;
forming said U-shaped member to fasten around and hold said sprinkler pipe and said pipe outlet with the help of locking units at said flanges;
forming said sealing member to comprise a watertight seal between said internal member and said pipe outlet; and
forming said fire sprinkler attachment to fit over said sprinkler pipe for receiving the entire external diameter of the pipe outlet and connecting to a smaller or larger diameter fire sprinkler.

10. The method of claim 9, wherein said sprinkler attachment comprises a configuration for fitting over a pipe outlet, such that an existing pipe outlet enables use for a larger sprinkler or pipe.

11. The method of claim 9, wherein said sprinkler attachment comprises a configuration for fitting the entire diameter of an existing pipe outlet with little loss in internal restriction.

12. The method of claim 9, further comprising, larger connections for adaptation of the sprinkler assembly to permit use in larger sprinkler systems while avoid the need for a mechanical tee (“T”) or similar fitting.

13. The method of claim 9, further comprising adaptation for a quick-connect attachment to said to a connection member of a fire sprinkler system.

14. The method of claim 9, wherein said connecting member comprises a metal, hard plastic or similarly rigid material.

15. The method of claim 9, further comprising a sealing member for providing a watertight seal between fire sprinkler attachment and an existing fire sprinkler system.

16. The method of claim 9, wherein said internal member fits over the outside diameter of the pipe outlet and a sealing member is made to sit in between said internal member and said pipe outlet.

17. The method of claim 9, further comprising configuration for sprinkler attachments of various sizes on a single fire sprinkler system.

18. A fire sprinkler system capable of adapting to different sized fire sprinkler attachments, comprising:
a fire sprinkler assembly comprising a fire sprinkler attachment connecting to said fire sprinkler and a sprinkler pipe, said fire sprinkler attachment configured to fit over a pipe outlet and to connect to a fire sprinkler or pipe;
said fire sprinkler attachment comprising a connecting member configured to receive a sprinkler connection portion of the fire sprinkler or pipe, said connecting member comprising an internal member and a sealing member;
said connecting member further comprising flanges comprising grooves, said flanges encompassing a U-shaped member for receiving a sprinkler pipe, said sprinkler pipe comprising a pipe outlet;
said U-shaped member fastening around and holding said sprinkler pipe and said pipe outlet with the help of locking units at said flanges;
said sealing member forming a watertight seal between said internal member and said pipe outlet;
said fire sprinkler attachment fitting over said sprinkler pipe for receiving the entire external diameter of the pipe outlet and connecting to a smaller or larger diameter fire sprinkler.

19. The fire sprinkler system of claim 18, wherein said sprinkler attachment comprises a configuration for fitting over a pipe outlet, such that an existing pipe outlet enables use for a larger sprinkler system.

20. The fire sprinkler system of claim 18, wherein said sprinkler attachment comprises a configuration for fitting the entire diameter of an existing pipe outlet with little loss in internal restriction.
